(19) United States
(12) Patent Application Publication
(10) Pub. No.: US 2026/0064077 A1
(43) Pub. Date: Mar. 5, 2026

(54) SYSTEM AND METHOD FOR GENERATING VIRTUAL LIGHT SOURCE AND VIRTUAL LIGHT SOURCE HOLOGRAM IMAGE

(71) Applicant: INDUSTRY-ACADEMIC COOPERATION FOUNDATION, YONSEI UNIVERSITY, Seoul (KR)

(72) Inventors: Young Joo KIM, Seoul (KR); Ki Baek KIM, Seoul (KR); Ju Won JUNG, Seoul (KR)

(21) Appl. No.: 19/302,932

(22) Filed: Aug. 18, 2025

(30) Foreign Application Priority Data
Sep. 2, 2024 (KR) 10-2024-0118305
Jul. 17, 2025 (KR) 10-2025-0096559

(51) Int. Cl. G03H 1/04; G06N 3/08

(52) U.S. Cl. CPC G03H 1/0443; G06N 3/08; G03H 2210/30; G03H 2222/34; G03H 2226/02

(57) ABSTRACT

An embodiment provides a virtual light source and virtual light source hologram image generation system and method, including: a hologram information acquisition unit that acquires at least one piece of hologram information using an optical system including a first light source and a second light source; an artificial neural network model deriving unit that performs machine learning using the hologram information and derives a learned artificial neural network model based on a machine learning result; a hologram image acquisition unit that acquires a hologram image of a specimen using the first light source; and a virtual light source hologram image output unit that inputs the hologram image transmitted from the hologram image acquisition unit into the learned artificial neural network model to generate and output a virtual light source hologram image, wherein the learned artificial neural network model is a virtual light source.

### CROSS REFERENCE TO RELATED APPLICATION

The present application claims priority to Korean Patent Application 10-2024-0118305, filed Sep. 2, 2024, and Korean Patent Application 10-2025-0096559, filed Jul. 17, 2025, the entire contents of which are incorporated here for all purposes by this reference.

### BACKGROUND

The disclosure relates to a virtual light source and virtual light source hologram image generation system and method, and more particularly, to a virtual light source and virtual light source hologram image generation system and method that generate a virtual light source capable of generating a clear hologram without compromising coherence characteristics through artificial intelligence learning and then generate a virtual light source hologram image using the virtual light source, in order to alleviate the problems of a light source used in digital holography.

Digital holography is currently attracting attention in fields requiring precision imaging.

Digital holography is an optical imaging technology that utilizes the coherence of light. By utilizing coherence, the wave nature of light, phase information on the wavefront of an object from an interference pattern formed on the object can be acquired as data, and then can then be reconstructed into a 3D image, including changes in the height, thickness, and refractive index.

Digital holography can be used to determine thickness and depth information, as well as internal density changes in opaque objects, based on the phase information, making it highly applicable to micro- and nano-scale objects.

However, digital holography has the following limitations:

Digital holography requires a highly coherent light source. When a highly coherent light source reflects off an object's surface, spackle noise, a random interference pattern generated by scattering, appears. This significantly impacts image quality and measurement accuracy in digital holography.

Furthermore, there are limitations imposed by the coherence length, which is the range of interference pattern generation depending on the light source. The coherence length is inversely proportional to the spectral width of the light source, and lasers, the high-coherence light source commonly used in digital holography, have a wide coherence length, while low-coherence light sources, such as LEDs, have a short coherence length.

One way to reduce spackle noise in digital holography is to use a light source with low coherence. Low coherence prevents light scattered from the surface of an object from interfering with it, thereby reducing spackle noise. However, using a light source with low coherence has the limitation of a shorter coherence length, which reduces the range at which interference patterns can be observed.

### RELATED ART DOCUMENT

### Patent Document

(Patent Document 1) Republic of Korea Publication Patent No. 10-2024-0030178 (2024 Mar. 7.)

### SUMMARY

An aspect of the disclosure is to provide a virtual light source and virtual light source hologram image generation system and method capable of acquiring high-resolution three-dimensional information in units of nanometers (nm) to micrometers (μm) and reconstructing a three-dimensional image of an object, while minimizing data loss and speckle noise, by performing learning on an artificial neural network model based on at least one piece of hologram information acquired using a high-coherence light source and a low-coherence light source to generate a virtual light source, and inputting a hologram image of a specimen acquired using the high-coherence light source into the learned artificial neural network model to generate a virtual light source hologram image.

The aspect of the disclosure is not limited to that mentioned above, and other aspects not mentioned will be clearly understood by those skilled in the art from the description below.

The disclosure provides a virtual light source and virtual light source hologram image generation system, including: a hologram information acquisition unit that acquires at least one piece of hologram information using an optical system including a first light source and a second light source; an artificial neural network model deriving unit that performs machine learning using the hologram information and derives a learned artificial neural network model based on a machine learning result; a hologram image acquisition unit that acquires a hologram image of a specimen using the first light source; and a virtual light source hologram image output unit that inputs the hologram image transmitted from the hologram image acquisition unit into the learned artificial neural network model to generate and output a virtual light source hologram image, wherein the learned artificial neural network model is a virtual light source.

In an embodiment of the disclosure, the optical system, based on a Michelson interferometer, may include a mirror for a reference wave and a reflective specimen for pattern generation.

In an embodiment of the disclosure, the first light source may be a high-coherence light source, and the second light source may be a low-coherence light source.

In an embodiment of the disclosure, if the central wavelengths of the first and second light sources are greater than a preset error, a QD film for a second light source may be further included in the second light source to correct the central wavelengths of the first and second light sources to be less than or equal to the preset error, and if the central wavelengths of the first and second light sources are less than or equal to the preset error, a thermoelectric cooler (TEC) may be further included in the first light source to match the central wavelengths.

In an embodiment of the disclosure, the first light source may be a light source that emits coherent light, and the second light source may be a light source that emits partially coherent light.

In an embodiment of the disclosure, the artificial neural network deriving unit may generate 1-1 hologram information and 2-1 hologram information using a sample with an optical path difference less than half the coherence length of the second light source, and use a conditional generational adversarial network (cGAN) for the machine learning.

In an embodiment of the disclosure, the artificial neural network deriving unit may perform learning on the generation model to generate a generation image that is an image that reproduces low-level speckle noise of the second light source based on data containing speckle noise from the first light source by applying an interference pattern of the 1-1 hologram information and the 2-1 hologram information to the generation model.

In an embodiment of the disclosure, the artificial neural network deriving unit may perform learning on a discrimination model so as to perform discrimination by comparing an image in which an interference pattern is generated at all locations of an optical path difference less than the coherence length from the second light source with the generated image.

In an embodiment of the disclosure, the virtual light source hologram image output unit may generate verification interference pattern data using a specimen with an optical path difference greater than half the coherence length of the second light source, in order to verify the learned artificial neural network model, and may perform verification by comparison thereof with the virtual light source hologram image.

In addition, the disclosure provides a method for generating a virtual light source and a virtual light source hologram image, the method including: a hologram information acquisition step in which a hologram information acquisition unit acquires at least one piece of hologram information using an optical system including a first light source and a second light source; an artificial neural network model deriving step in which an artificial neural network model deriving unit performs machine learning using the hologram information and derives a learned artificial neural network model based on a machine learning result; a hologram image acquisition step in which a hologram image acquisition unit acquires a hologram image of a specimen using the first light source; and a virtual light source hologram image output step in which a virtual light source hologram image output unit generates and outputs a virtual light source hologram image, which is a hologram image using a virtual light source, using the learned artificial neural network model, wherein the learned artificial neural network model is a virtual light source.

The effects of the disclosure are acquiring high-resolution three-dimensional information in units of nanometers (nm) to micrometers (μm) and reconstructing a three-dimensional image of an object, while minimizing data loss and speckle noise, by performing learning on an artificial neural network model based on at least one piece of hologram information acquired using a high-coherence light source and a low-coherence light source to generate a virtual light source, and inputting a hologram image of a specimen acquired using the high-coherence light source into the learned artificial neural network model to generate a virtual light source hologram image.

The effects of the disclosure are not limited to the effects described above, and should be understood to include all effects that are inferable from the configuration of the disclosure described in the detailed description or claims of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of a virtual light source and virtual light source hologram image generation system according to an embodiment of the disclosure;

FIG. 2 is an exemplary view of an optical system used in an embodiment of the disclosure;

FIG. 3 is an exemplary view of obtaining an interference pattern or hologram by emitting light onto a reflective specimen for pattern generation according to an embodiment of the disclosure;

FIG. 4 is a flowchart of a method for generating a virtual light source for hologram image generation according to an embodiment of the disclosure;

FIGS. 5A-5C show (A) a pixel-by-pixel density comparison of holograms of a first light source and a second light source, (B) a schematic view of a virtual light source development using artificial intelligence, and (C) a conceptual representation of the effectiveness of a virtual light source hologram image according to an embodiment of the disclosure;

FIGS. 6A-6C show (A) a luminescence pattern induced by a UV lamp with a QD film mounted in a simulation experiment of the disclosure, (B) a corrected wavelength spectrum from a first light source and a second light source with an added QD film, and (C) an interference pattern generated using the first and second light sources;

FIGS. 7A-7B show interference patterns between two light sources in an embodiment, showing (A) a consistent interference pattern and (B) an inconsistent interference pattern due to excessive OPD;

FIGS. 8A-8B show hologram images (A) when the optical path difference is 1.8 μm and (B) when the optical path difference is 8.0 μm, according to an embodiment of the disclosure; and

FIGS. 9A-9F show, in this simulation, (A) a hologram acquired from a specimen at a depth of 8.0 μm using a first light source, (B) a quantitative phase map derived from the laser hologram, (C) a virtual light source hologram image generated by a virtual light source using the initial laser hologram as input, (D) a quantitative phase map derived from the virtual light source hologram image, (E) a surface depth distribution at the red and blue lines shown in FIGS. 9B and 9D, respectively, and (F) a 3D reconstruction graph of the surface depth distribution using a virtual light source.

FIG. 9B is a dual-wavelength phase-shift of the laser hologram shown in FIG. 9A.

FIG. 9C is a transformation of the laser hologram shown in FIG. 9A.

FIG. 9D is a dual-wavelength phase-shift of the laser hologram shown in FIG. 9B.

### DETAILED DESCRIPTION

Hereinafter, the disclosure will be described with reference to the accompanying drawings. However, the disclosure may be implemented in various different forms and therefore is not limited to the embodiments described herein. In addition, in order to clearly describe the disclosure in the drawings, parts that are not related to the description are omitted, and similar parts are given similar drawing reference numerals throughout the specification.

In the entire specification, when a part is said to be “connected (linked, contacted, coupled)” to another part, this includes not only the case where it is “directly connected” but also the case where it is “indirectly connected” with another member in between. In addition, when a part is said to “include” a certain component, this does not exclude other components unless specifically stated to the contrary, but rather means that other components may be additionally provided.

The terms used in this specification are used only to describe specific embodiments and are not intended to limit the disclosure. The singular expression includes the plural expression unless the context clearly indicates otherwise. In this specification, the terms “include” or “have” are intended to specify the presence of a feature, number, step, operation, component, part, or combination thereof described in the specification, but should be understood as not excluding in advance the possibility of the presence or addition of one or higher other features, numbers, steps, operations, components, parts, or combinations thereof.

Hereinafter, embodiments of the disclosure will be described in detail with reference to the accompanying drawings.

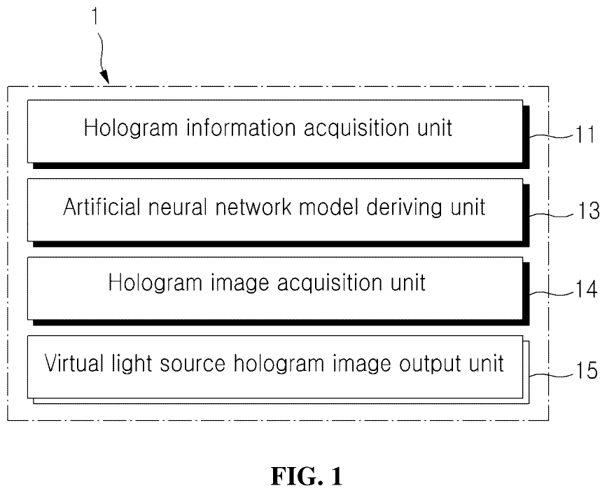

FIG. 1 shows an embodiment of a virtual light source and virtual light source hologram image generation system of the disclosure.

The virtual light source and virtual light source hologram image generation system (1) according to an embodiment of the disclosure includes a virtual light source generation system (11, 13) and a virtual light source holography system (14, 15).

Specifically, the virtual light source and virtual light source hologram image generation system (1) according to an embodiment of the disclosure may be configured to generate a virtual light source hologram image by generating a hologram through two light sources using an optical system, learning the interference pattern of the generated hologram to derive an artificial neural network model, and generating a virtual light source using this model. The virtual light source and virtual light source hologram image generation system (1) according to an embodiment of the disclosure may be configured to include a hologram information acquisition unit (11), an artificial neural network model deriving unit (13), a hologram image acquisition unit (14), and a virtual light source hologram image output unit (15), as shown in FIG. 1.

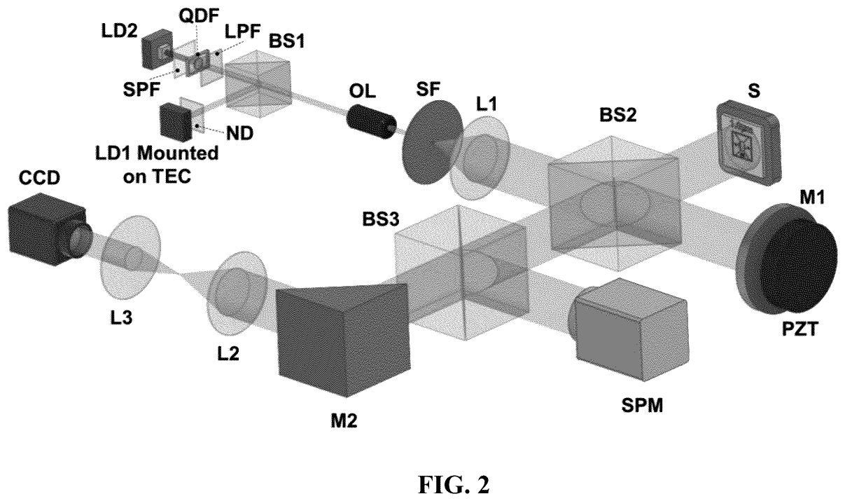

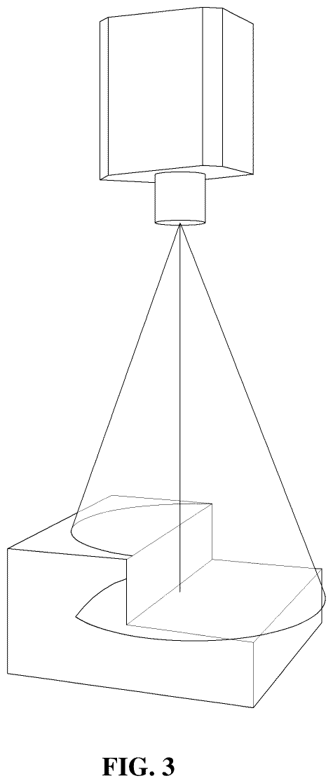

The hologram information acquisition unit (11) is configured to acquire at least one piece of hologram information using an optical system including a first light source and a second light source. Here, the optical system may be an optical system based on a Michelson interferometer, as shown in FIG. 2, and may be a system configured to emit different light using the first and second light sources, thereby generating hologram information.

In addition, the optical system according to an embodiment of the disclosure may be configured to include a mirror for a reference wave and a reflective specimen for pattern generation, based on a Michelson interferometer.

When the center wavelengths of the first and second light sources of the disclosure are different, the hologram information acquisition unit (11) according to an embodiment of the disclosure may be configured to further include a QD film for the second light source to align the center wavelengths of the first and second light sources.

Here, the first light source may be a high-coherence light source. In an embodiment, it may be coherent light. In a more specific embodiment, it may be output using a laser. In addition, the second light source may be a low-coherence light source. In an embodiment, it may be partially coherent light. In a more specific embodiment, it may be output using an LED or QD film-based light source. However, the first and second light sources described above are not limited to lasers or LEDs, and various light sources capable of emitting light with either high-coherence or low-coherence properties may be used as the first and second light sources.

Furthermore, the holographic information obtained using the first light source may be first holographic information, and the holographic information obtained using the second light source may be second holographic information.

Furthermore, the first holographic information may be a hologram generated using a high-coherence light source, and the second holographic information may be a hologram generated using a low-coherence light source.

An artificial neural network model deriving unit (13) according to an embodiment of the disclosure is configured to perform machine learning using hologram information and derive a learned artificial neural network model from the machine learning results.

The artificial neural network model deriving unit (13) according to the disclosure generates 1-1 hologram information and 2-1 hologram information using a specimen with an optical path difference less than half the coherence length of a second light source, and utilizes a conditional generational adversarial network (cGAN) for machine learning. Hereinafter, when a specimen has an optical path difference less than half the coherence length of the second light source, n−1 hologram information is generated, and when the specimen has an optical path difference greater than half the coherence length of the second light source, n−2 hologram information is generated.

The conditional generational adversarial network according to an embodiment of the disclosure may be configured to include a generation model and a discrimination model. The generation model is provided to generate training data, and the discrimination model may be configured to determine how much the generated training data differs from reality and use the results to determine whether the training data has been learned.

The generation model may be trained to acquire interference patterns of the 1-1 hologram information and the 2-1 hologram information and, using these patterns, generate a generation image, which is an image that reproduces the low-level spackle noise of the second light source, based on data containing spackle noise of the first light source. That is, if the generation model acquires interference patterns of the 1-1 hologram information and the 2-1 hologram information, the acquired interference patterns may be learned, and, as a result of the learning, a generation image, which is hologram information in which the spackle noise of the 1-1 hologram information is replaced with the low-level spackle noise of the 2-1 hologram information, may be generated.

A discrimination model is configured to generate an image in which an interference pattern is generated at all locations with an optical path difference less than the coherence length of the second light source, as a discrimination reference image, and to compare the discrimination reference image with the generation image to determine whether the generation image passes the criteria.

Using such a generation model and discrimination model, the artificial neural network model deriving unit (13) according to an embodiment of the disclosure may be configured to generate a generation image and an artificial neural network model capable of generating a virtual light source capable of generating the generation image.

As described above, the artificial neural network model learned by the artificial neural network model deriving unit (13) may be a virtual light source.

The hologram image acquisition unit (14) acquires a hologram image of the specimen using the first light source.

Here, the specimen may be a measurement specimen for actual measurement.

Specifically, the hologram image acquisition unit (14) controls the second light source to be turned off, and controls only the first light source to be turned on.

Accordingly, the hologram image acquisition unit (14) acquires a hologram image of the specimen by measuring the reflected light from the high-coherence light source irradiated from the first light source onto the specimen, and the acquired hologram image can be measured within the range measurable by the high-coherence light source without any depth limitations.

The virtual light source hologram image output unit (15) is configured to input the hologram image transmitted from the hologram image acquisition unit into a trained artificial neural network model to generate and output a virtual light source hologram image.

The virtual light source hologram image output unit (15) of the disclosure uses the trained artificial neural network model to generate and output a virtual light source hologram image, which is a hologram image using a virtual light source. Here, the virtual light source may be referred to as a pseudo-light source.

The virtual light source hologram image output unit (15) according to an embodiment of the disclosure may verify a learned artificial neural network model and generate and output a virtual light source hologram image based on the verification results. To this end, the virtual light source hologram image output unit (15) according to the disclosure may generate verification interference pattern data using a specimen with an optical path difference greater than half the coherence length of the second light source to verify the learned artificial neural network model. The generated verification interference pattern data is used to verify the virtual light source hologram image by comparing it with the virtual light source hologram image; if the verification passes, the virtual light source hologram image output unit (15) according to an embodiment of the disclosure may output the corresponding image as a virtual light source hologram image, which is a hologram image using a virtual light source.

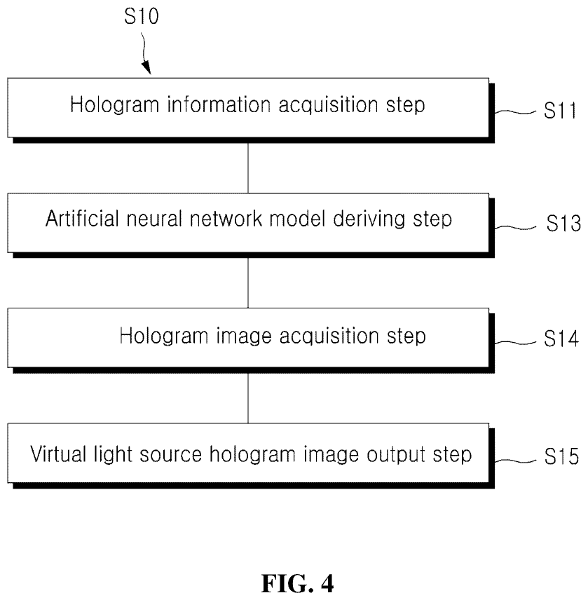

Meanwhile, FIG. 4 shows an embodiment of a method for generating a virtual light source for hologram image generation according to the disclosure. Hereinafter, the following description uses FIG. 1 for convenience of explanation, but the disclosure is not limited thereto, and devices, systems, and terminals capable of performing various similar functions or operations may also be utilized.

A method (S10) for generating a virtual light source for hologram image generation according to an embodiment of the disclosure may be configured to generate a virtual light source hologram image by generating a hologram through two light sources using an optical system, learning the interference pattern of the generated hologram to derive an artificial neural network model, and generating a virtual light source using this model. The method (S10) for generating a virtual light source for hologram image generation according to an embodiment of the disclosure may be configured to include a hologram information acquisition step (S11), an artificial neural network model deriving step (S13), a hologram image acquisition step (14), and a virtual light source hologram image output step (S15), as shown in FIG. 4.

The hologram information acquisition step (S11) is configured to acquire at least one piece of hologram information using an optical system including a first light source and a second light source. Here, the optical system may be an optical system based on a Michelson interferometer, as shown in FIG. 2, and may be a system configured to emit different light using the first and second light sources, thereby generating hologram information.

In addition, the optical system according to an embodiment of the disclosure may be configured to include a mirror for a reference wave and a reflective specimen for pattern generation, based on a Michelson interferometer.

When the center wavelengths of the first light source and the second light source of the disclosure are different, the hologram information acquisition step (S11) according to an embodiment of the disclosure may be configured to match the center wavelengths of the first and second light sources by further including a QD film for the second light source in the second light source.

Here, the first light source may be a high-coherence light source. In an embodiment, it may be coherent light. In a more specific embodiment, it may be output using a laser. In addition, the second light source may be a low-coherence light source, may be partially coherent light in an embodiment, and may be output using an LED or QD film-based light source in a more specific embodiment. However, the first and second light sources described above are not limited to lasers or LEDs, and various light sources capable of emitting light with either high-coherence or low-coherence properties may be used as the first and second light sources.

Furthermore, the holographic information obtained using the first light source may be first holographic information, and the holographic information obtained using the second light source may be second holographic information.

Furthermore, the first holographic information may be a hologram generated using a high-coherence light source, and the second holographic information may be a hologram generated using a low-coherence light source.

According to an embodiment of the disclosure, the artificial neural network model deriving step (S13) is configured to perform machine learning using hologram information and derive an artificial neural network model learned from the machine learning results.

The artificial neural network model deriving step (S13) of the disclosure is configured to generate 1-1 hologram information and 2-1 hologram information using a sample with an optical path difference less than half the coherence length of the second light source, and to utilize a conditional generational adversarial network (cGAN) for machine learning. Hereinafter, when a specimen has an optical path difference less than half the coherence length of the second light source, n−1 hologram information is generated, and when the specimen has an optical path difference greater than half the coherence length of the second light source, n−2 hologram information is generated.

The conditional generational adversarial network according to an embodiment of the disclosure may be configured to include a generation model and a discrimination model. The generation model is provided to generate training data, and the discrimination model may be configured to determine how much the generated training data differs from reality and use the results to determine whether the training data has been learned.

The generation model may be trained to acquire interference patterns of the 1-1 hologram information and the 2-1 hologram information and, using these patterns, generate a generation image, which is an image that reproduces the low-level spackle noise of the second light source, based on data containing spackle noise of the first light source. That is, if the generation model acquires interference patterns of the 1-1 hologram information and the 2-1 hologram information, the acquired interference patterns may be learned, and, as a result of the learning, a generation image, which is hologram information in which the spackle noise of the 1-1 hologram information is replaced with the low-level spackle noise of the 2-1 hologram information, may be generated.

A discrimination model is configured to generate an image in which an interference pattern is generated at all locations with an optical path difference less than the coherence length of the second light source, as a discrimination reference image, and to compare the discrimination reference image with the generation image to determine whether the generation image passes the criteria.

Using these generation models and discrimination models, the artificial neural network model deriving step (S13) according to an embodiment of the disclosure may be configured to generate an artificial neural network model capable of generating a generation image and a virtual light source capable of generating the generation image.

Here, the trained artificial neural network model may be a virtual light source.

The hologram image acquisition step (S14) acquires a hologram image of the specimen using the first light source in the hologram image acquisition unit (14).

The virtual light source hologram image output step (S15) is configured to generate and output a virtual light source hologram image, which is a hologram image using a virtual light source, using the trained artificial neural network model.

The virtual light source hologram image output step (S15) of the disclosure is configured to generate and output a virtual light source hologram image, which is a hologram image using a virtual light source, using the trained artificial neural network model. Here, the virtual light source may be referred to as a pseudo-light source.

The virtual light source hologram image output step (S15) according to an embodiment of the disclosure may verify a learned artificial neural network model and generate and output a virtual light source hologram image based on the verification results. To this end, the virtual light source hologram image output step (S15) of the disclosure may generate verification interference pattern data using a specimen with an optical path difference greater than half the coherence length of the second light source to verify the learned artificial neural network model. The generated verification interference pattern data is used to verify the virtual light source hologram image by comparing it with the virtual light source hologram image, and if the verification passes, the virtual light source hologram image output step (S15) according to an embodiment of the disclosure may output the corresponding image as a virtual light source hologram image, which is a hologram image using a virtual light source.

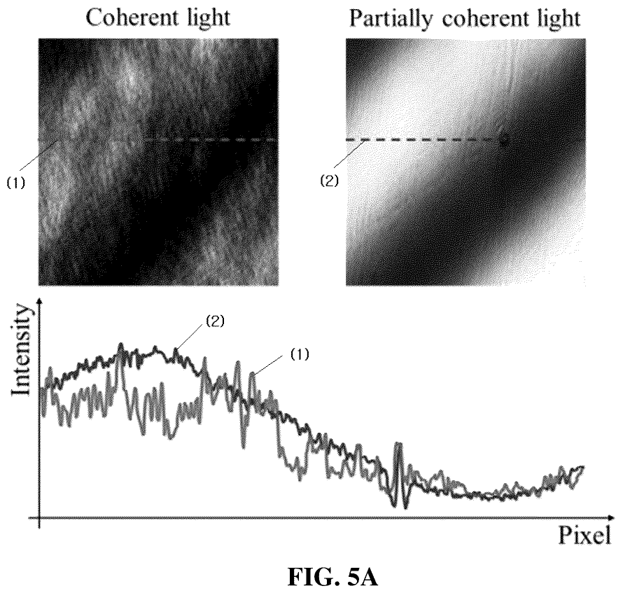

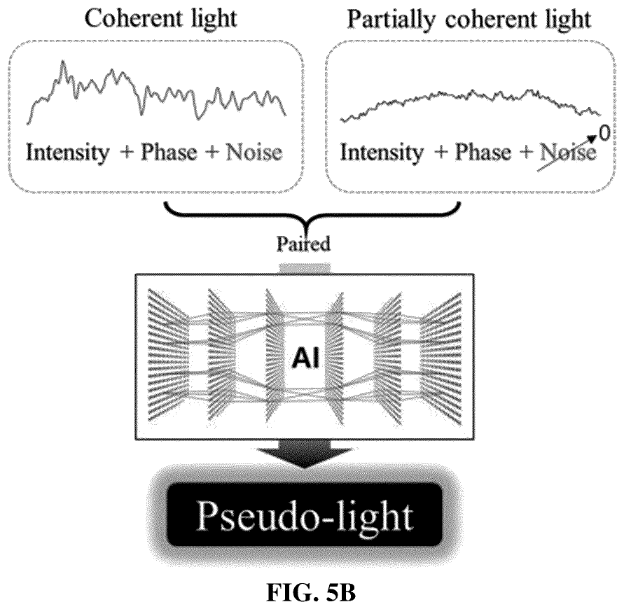

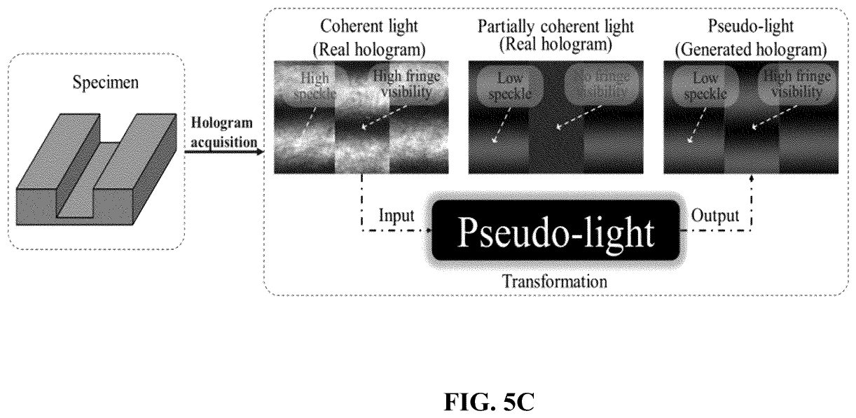

FIG. 5 shows (A) a pixel-by-pixel density comparison of holograms of a first light source and a second light source, (B) a schematic view of a virtual light source development using artificial intelligence, and (C) a conceptual representation of the effectiveness of a virtual light source hologram image according to an embodiment of the disclosure.

FIG. 5A shows a holographic image acquired from a chrome-coated mirror using both a coherent light source and a partially coherent light source, each having a full-width-at-half-maximum (FWHM) of 2.81 nm and 39.71 nm, respectively, in an embodiment of the disclosure. Here, the image on the left may be the first holographic image, and the image on the right may be the second holographic image. Comparing the same portion of the two holographic images reveals that each pixel has different intensities, as shown in the lower image, and it is possible to confirm that the second holographic image exhibits virtually no noise.

Therefore, the disclosure, of which the idea was inspired by these features, combines a first light source and a second light source, as shown in FIG. 5B, generates a pseudo-light source (hereinafter, referred to as a PLS for convenience) with a combination of the strengths of both sources through artificial intelligence (machine learning), and generates a hologram image using the PLS, thereby enabling the acquisition of an image that encompasses both strengths.

FIG. 5C shows the concept of the effectiveness of a virtual light source hologram. The disclosure utilizes the aforementioned PLS to generate a virtual light source hologram image that not only removes noise but also includes holograms that were previously impossible to generate.

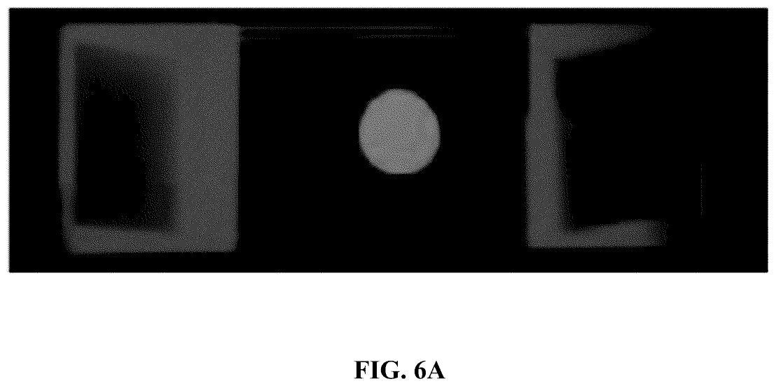

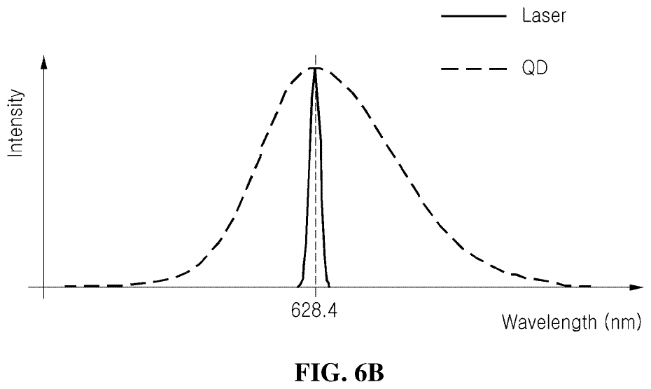

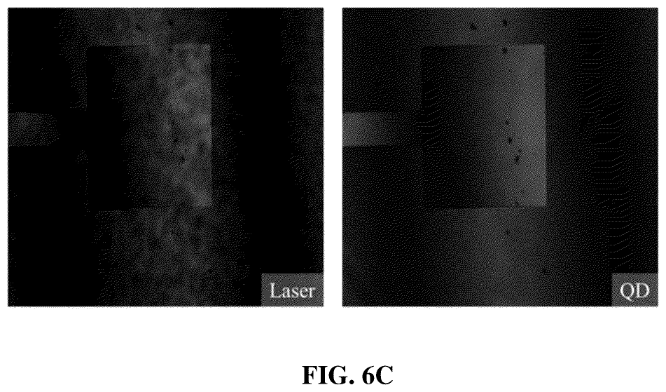

Experiments were conducted to verify the system and method according to an embodiment of the disclosure. The experiments utilized the optical system shown in FIG. 2, and more specifically, a QD film with a peak emission wavelength of 628.4 nm was added to transform the second light source into a quantum dot (QD)-based light source. FIG. 6 shows (A) a luminescence pattern induced by a UV lamp with a QD film mounted in a simulation experiment of the disclosure, (B) a corrected wavelength spectrum from a first light source and a second light source with an added QD film, and (C) an interference pattern generated using the first and second light sources.

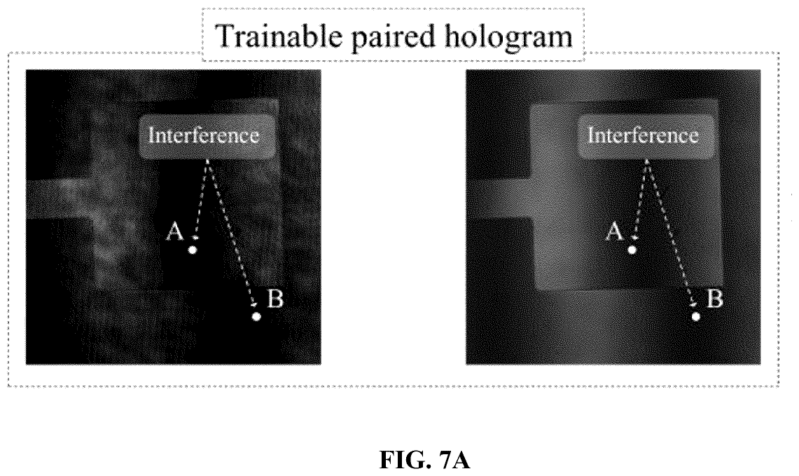

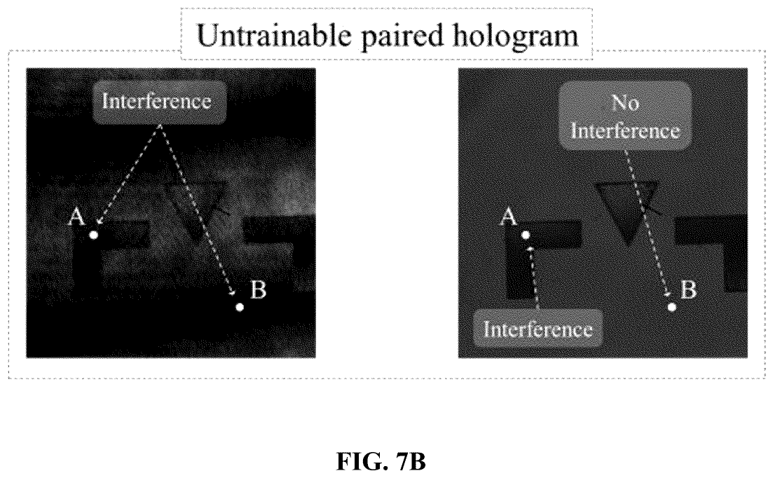

Referring to FIG. 6, the disclosure effectively integrates the center wavelengths of the first and second light sources by using a QD film. More specifically, FIG. 7A shows a consistent interference pattern, while FIG. 7B shows that the interference pattern seen in the laser hologram is not displayed due to excessive OPD, confirming the importance of having an appropriate center wavelength.

In one experiment of the disclosure, a thermoelectric cooler (TEC) was used to match the wavelengths of the first and second light sources, and to effectively integrate the center wavelengths of the first and second light sources, a QD film was used to initially set the center wavelengths to be similar, and the TEC was then coupled to the first light source to ensure the same center wavelength.

Furthermore, a conditional generational adversarial network (cGAN) was used to generate PLS, and to verify the integrity of the phase information within the hologram generated using PLS, the simulation experiment of the disclosure utilized a dual-wavelength phase-shift hologram technique for axis measurement. This technique captures holograms using incremental phase shifts introduced into a reference wave. Here, the phase difference between consecutive holograms may be calculated using Equation 1 below.

$$θ = {tan}^{- 1} ( \frac{{I}_{3} - {I}_{1}}{{I}_{0} - {I}_{2}} ) \qquad Equation 1$$

Here, I0 to I3 may represent the intensities of holograms captured at phase shifts of 0, π/2, π, and 3π/2. Furthermore, by synthesizing the wavelengths of two lights (light emitted from the first and second light sources) for the interference pattern, a synthesized light wavelength may be obtained, as expressed by Equation 2 below.

$${Λ}_{12} = \frac{{λ}_{1} {λ}_{2}}{\vert {λ}_{1} - {λ}_{2} \vert} \qquad Equation 2$$

This simulation experiment was conducted using the concepts described above, specifically using light sources with wavelengths of 628.4 nm and 634.2 nm. Furthermore, a 1.8 μm specimen with an optical path difference smaller than the coherence length was used.

To quantify speckle noise, this simulation introduced the speckle noise contrast value, defined as the standard deviation of intensity fluctuations relative to the average intensity value within the region of interest, and this value can be expressed as Equation 3 below.

$$C = \frac{\sqrt{\frac{1}{MN} {\sum }_{i = 1 , j = 1}^{M , N} {( {I}_{i , j} - \overline{I} )}^{2}}}{\overline{I}} \qquad Equation 3$$

Here, M and N represent the rows and columns of the region of interest, respectively, Ii,j represent the intensity values at specific locations (x,y), and Ī represents the average intensity of the region of interest.

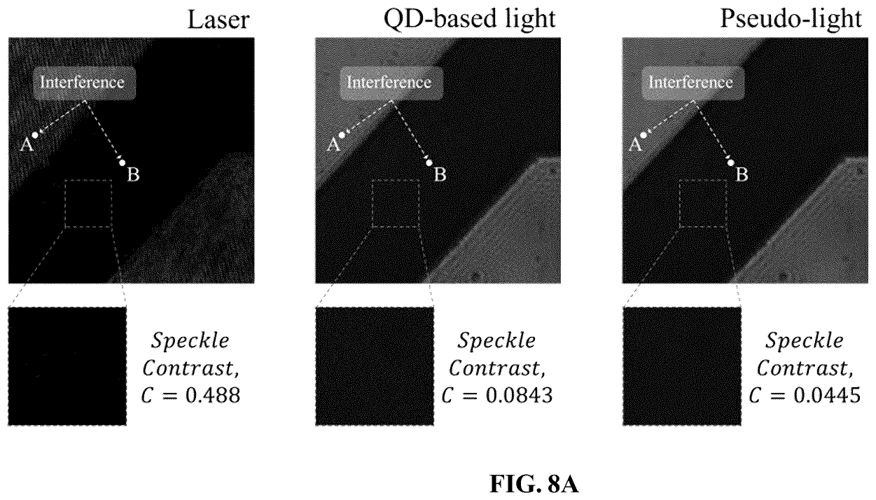

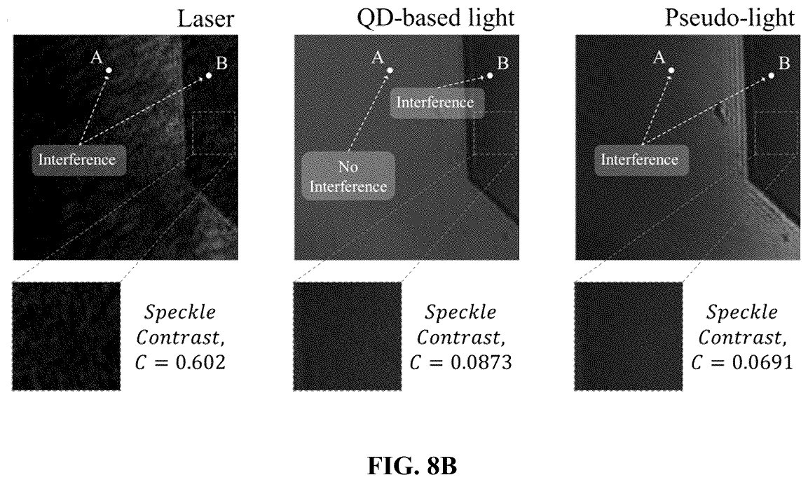

FIG. 8 shows hologram images (A) when the optical path difference is 1.8 μm and (B) when the optical path difference is 8.0 μm, according to an embodiment of the disclosure.

FIG. 8A shows interference patterns similar to those obtained using the first and second light sources at points A and B of a virtual light source hologram image generated by a virtual light source. This virtual light source hologram image, calculated using Equation 3 described above, exhibited a reduced speckle noise contrast of 0.0445, demonstrating a significant noise reduction compared to the results obtained using the first light source.

Meanwhile, FIG. 8B shows an OPD of 16.0 μm due to the optical path difference of 8.0 μm. Looking at FIG. 8B, the first light source generates a distinct interference pattern, but the speckle noise contrast is high at 0.602. In addition, the second light source exhibited a low speckle noise contrast of 0.0873 at point B, but failed to produce an interference pattern at point A because the OPD was greater than the optical path difference.

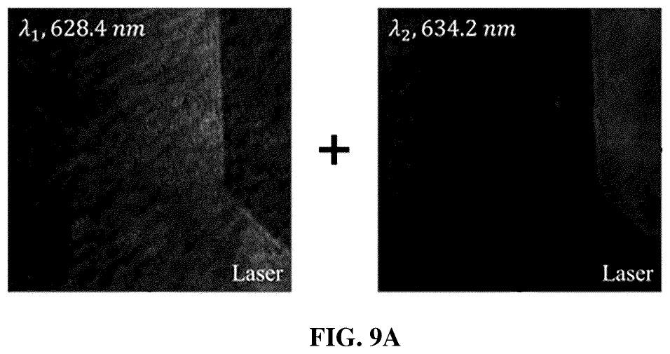

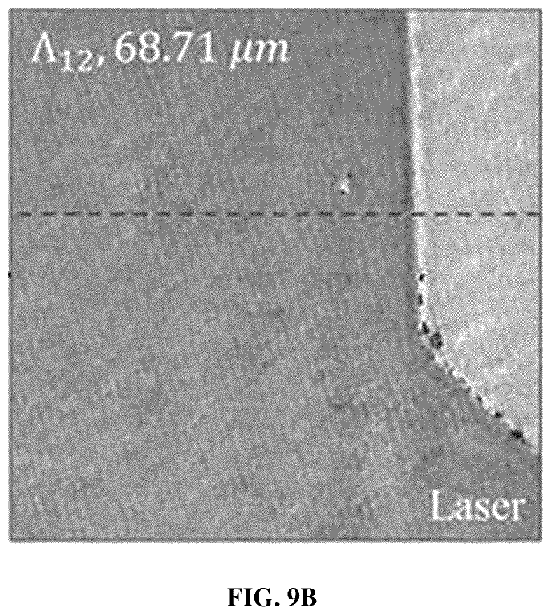

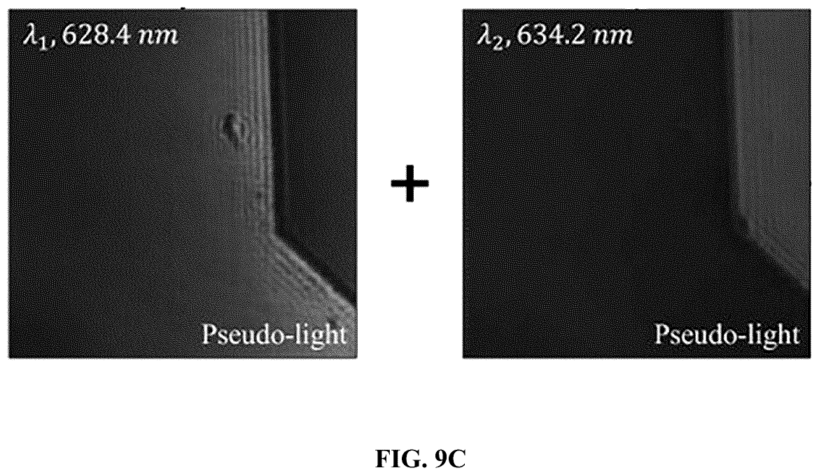

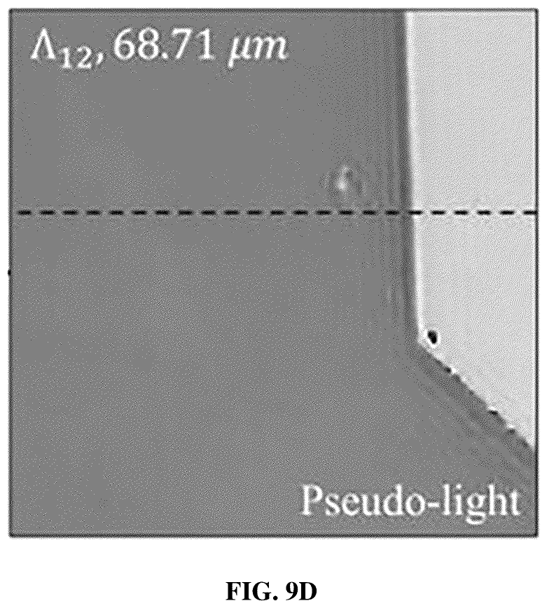

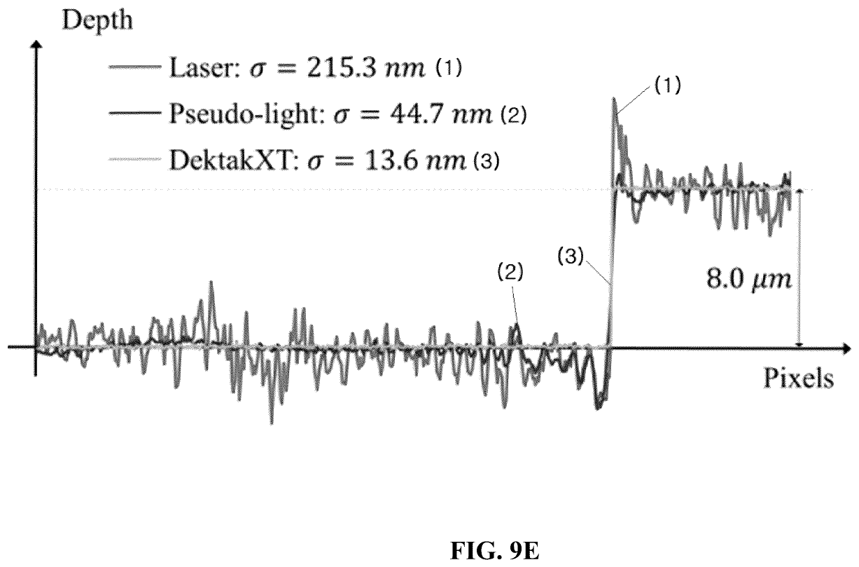

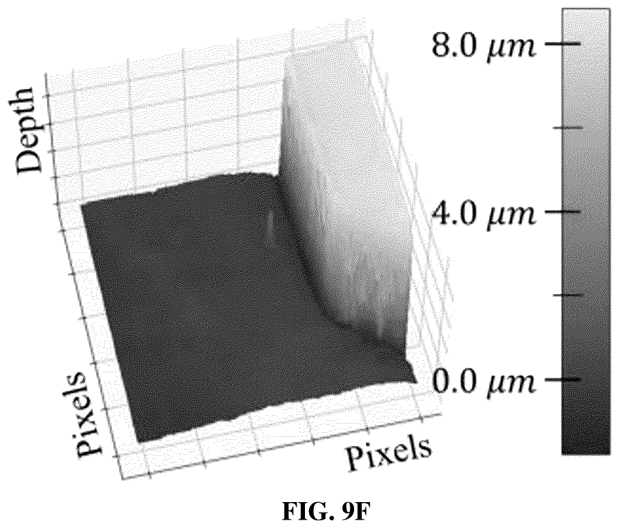

FIG. 9 shows (A) a hologram acquired from an 8.0 μm-deep specimen using the first light source in this simulation, (B) a quantitative phase map derived from the laser hologram, (C) a virtual light source hologram image generated by PLS using the initial laser hologram as input, (D) a quantitative phase map derived from the virtual light source hologram image, (E) the surface depth distribution along the red and blue lines shown in FIGS. 9B and 9D, respectively, and (F) a 3D reconstruction graph of the surface depth distribution using PLS.

FIG. 9B is a dual-wavelength phase-shift of the laser hologram shown in FIG. 9A.

FIG. 9C is a transformation of the laser hologram shown in FIG. 9A.

FIG. 9D is a dual-wavelength phase-shift of the laser hologram shown in FIG. 9B.

Referring to FIG. 9, the simulation results show that using PLS reduces noise, resulting in a smaller standard deviation (44.7 nm), and these simulation results also confirm that the hologram image generated by the PLS of the disclosure has a higher resolution than holograms generated using conventional first and second light sources.

The virtual light source generation method for holographic image generation according to the embodiments of the disclosure described above may be implemented as an application (computer program) stored on a computer storage medium.

Here, the computer may include a virtual light source and a virtual light source hologram image generation system.

The computer's operating system may be an operating system such as Windows or Macintosh, installed on general PCs such as desktops and laptops, or a mobile-specific operating system such as iOS or Android, installed on mobile devices such as smartphones and tablet PCs.

The virtual light source generation method for holographic image generation according to the embodiments of the disclosure described above may be implemented as an application (i.e., a computer program) installed by default on a computer or by a user, and stored (recorded) on a computer-readable storage medium.

Likewise, in order for a computer to read a program recorded on a storage medium and execute the virtual light source generation method for holographic image generation according to the embodiments implemented as a program, the aforementioned application (application program) may include code encoded in a computer language readable by the computer's processor (CPU), such as C, C++, JAVA, or machine language.

This code may include functional code related to functions defining the aforementioned functions, and may also include control code related to execution procedures required for the computer's processor to execute the aforementioned functions according to a predetermined procedure.

In addition, this code may further include memory reference code that specifies the location (address) of the computer's internal or external memory at which additional information or media required for the computer's processor to execute the aforementioned functions should be referenced.

Furthermore, if the computer's processor requires communication with another remote computer or server to execute the aforementioned functions, the code may further include communication-related code that describes how the computer's processor should communicate with another remote computer or server using the computer's communication module (e.g., wired and/or wireless communication module), what information or media should be sent and received during communication, etc.

Functional programs for implementing the present embodiments, as well as code and code segments related thereto, may be easily inferred or modified by programmers skilled in the art, taking into account the system environment of the computer that reads the storage medium and executes the program.

In addition, a computer-readable storage medium recording the aforementioned program may be distributed across network-connected computer systems, allowing the computer-readable code to be stored and executed in a distributed manner. In this case, one or more of the multiple distributed computers may execute some of the functions described above and transmit the results to one or more of the other distributed computers, and the computer receiving the results may also execute some of the functions described above and provide the results to the other distributed computers.

The computer-readable storage medium recording the application for executing the virtual light source generation method for holographic image generation according to the embodiments of the disclosure, as described above, may include, for example, ROM, RAM, CD-ROM, magnetic tape, floppy disk, or optical media storage devices.

In addition, a computer-readable storage medium recording an application program for executing a virtual light source generation method for holographic image generation according to embodiments of the disclosure may be a storage medium (e.g., a hard disk drive) included in an application provider server (ASP), including an application store server, a web server related to the application or its service, may be the application provider server itself, or may also be another computer or its storage medium recording the program.

A computer capable of reading a storage medium recording an application program for executing a virtual light source generation method for holographic image generation according to embodiments of the disclosure may include not only general PCs such as desktops or laptops, but also mobile terminals such as smartphones, tablet PCs, Personal Digital Assistants (PDAs), and mobile communication terminals. Furthermore, the term “computer-readable storage medium” should be interpreted as encompassing any computing-capable device.

The description of the disclosure is for illustrative purposes, and those skilled in the art will understand that it can be easily modified into other specific forms without changing the technical idea or essential features of the disclosure. Therefore, the embodiments described above should be understood as being exemplary in all respects and not limiting. For example, each component described as a single type may be implemented in a distributed manner, and likewise, components described as distributed may be implemented in a combined form.

The scope of the disclosure is indicated by the following claims, and all changes or modifications derived from the meaning and scope of the claims and their equivalent concepts should be interpreted as being included in the scope of the disclosure.

### EXPLANATION OF REFERENCE NUMERALS

1: virtual light source and virtual light source hologram image generation system
11: hologram information acquisition unit
13: artificial neural network model deriving unit
14: hologram image acquisition unit
15: virtual light source hologram image output unit

What is claimed is:

1. A virtual light source and virtual light source hologram image generation system, comprising:
a hologram information acquisition unit configured to acquire at least one piece of hologram information using an optical system comprising a first light source and a second light source;
an artificial neural network model deriving unit configured to perform machine learning using the hologram information and to derive a learned artificial neural network model based on a machine learning result;
a hologram image acquisition unit configured to acquire a hologram image of a specimen using the first light source; and
a virtual light source hologram image output unit configured to input the hologram image transmitted from the hologram image acquisition unit into the learned artificial neural network model to generate and output a virtual light source hologram image,
wherein the learned artificial neural network model is the virtual light source.

2. The virtual light source and virtual light source hologram image generation system of claim 1, wherein the optical system, based on a Michelson interferometer, comprises a mirror for a reference wave and a reflective specimen for pattern generation.

3. The virtual light source and virtual light source hologram image generation system of claim 1, wherein the first light source is a high-coherence light source, and the second light source is a low-coherence light source.

4. The virtual light source and virtual light source hologram image generation system of claim 3, wherein when a difference between central wavelengths of the first and second light sources is greater than a preset error, the second light source further comprises a QD film to correct the central wavelengths of the first and second light sources to be less than or equal to the preset error, and when the difference between the central wavelengths of the first and second light sources is less than or equal to the preset error, the first light source further comprises a thermoelectric cooler (TEC) to match the central wavelengths.

5. The virtual light source and virtual light source hologram image generation system of claim 4, wherein the first light source is configured to emit coherent light, and the second light source is configured to emit partially coherent light.

6. The virtual light source and virtual light source hologram image generation system of claim 1, wherein the artificial neural network model deriving unit is configured to generate 1-1 hologram information and 2-1 hologram information using a sample with an optical path difference less than half a coherence length of the second light source, and to use a conditional generational adversarial network (cGAN) for the machine learning.

7. The virtual light source and virtual light source hologram image generation system of claim 6, wherein the artificial neural network model deriving unit is configured to perform learning on a generation model to generate a generation image that reproduces low-level speckle noise of the second light source based on data containing speckle noise from the first light source by applying an interference pattern of the 1-1 hologram information and the 2-1 hologram information to the generation model.

8. The virtual light source and virtual light source hologram image generation system of claim 7, wherein the artificial neural network model deriving unit is configured to perform learning on a discrimination model to perform discrimination by comparing an image in which an interference pattern is generated at all locations of an optical path difference less than the coherence length from the second light source with the generated image.

9. The virtual light source and virtual light source hologram image generation system of claim 1, wherein the virtual light source hologram image output unit is configured to generate verification interference pattern data using a specimen with an optical path difference greater than half a coherence length of the second light source, in order to verify the learned artificial neural network model, and to perform verification by comparison thereof with the virtual light source hologram image.

10. A method for generating a virtual light source and a virtual light source hologram image, the method comprising:
a hologram information acquisition step in which a hologram information acquisition unit is configured to acquire at least one piece of hologram information using an optical system comprising a first light source and a second light source;
an artificial neural network model deriving step in which an artificial neural network model deriving unit is configured to perform machine learning using the hologram information and to derive a learned artificial neural network model based on a machine learning result;
a hologram image acquisition step in which a hologram image acquisition unit is configured to acquire a hologram image of a specimen using the first light source; and
a virtual light source hologram image output step in which a virtual light source hologram image output unit is configured to generate and output the virtual light source hologram image, which is a hologram image using the virtual light source, using the learned artificial neural network model,
wherein the learned artificial neural network model is the virtual light source.
